(19) United States
(12) Patent Application Publication
(10) Pub. No.: US 2014/0313010 A1
(43) Pub. Date: Oct. 23, 2014

(54) ACCESS CONTROL SYSTEM

(71) Applicant: PKinno Inc., New Taipei City (TW)

(72) Inventors: Jing-Jung HUANG, New Taipei City (TW); Chi-Chang LEE, New Taipei City (TW); Chin-Yu HUANG, New Taipei City (TW); Chi-Lin WU, New Taipei City (TW)

(73) Assignee: PKinno Inc., New Taipei City (TW)

(21) Appl. No.: 14/254,580

(22) Filed: Apr. 16, 2014

(30) Foreign Application Priority Data
Apr. 23, 2013 (TW) 102114379

(51) Int. Cl. G07C 9/00

(52) U.S. Cl. CPC G07C 9/00111
USPC 340/5.61

(57) ABSTRACT

An access control system includes a portable user device, an access control apparatus and a portable administrator device. The access control apparatus includes a first near field communication (NFC) unit and stores a first valid user list. The portable administrator device includes a second NFC unit and stores a second valid user list. The first NFC unit and the second NFC unit are operable to enable communication between the access control apparatus and the portable administrator device, and the access control apparatus and the portable administrator device are operable to synchronize contents of the first valid user list stored in the access control apparatus and the second valid user list stored in the portable administrator device.

### CROSS-REFERENCE TO RELATED APPLICATION

This application claims priority of Taiwanese Application No. 102114379, filed on Apr. 23, 2013.

### BACKGROUND OF THE INVENTION

1. Field of the Invention

The invention relates to an access control system, more particularly to an access control system that utilizes near field communication.

2. Description of the Related Art

A conventional access control system (e.g., used for controlling access to a building) includes an access control apparatus placed at an entrance of the building, an administrator server and a plurality of card keys. The administrator server maintains and provides the access control apparatus with an authorization list having a plurality of authorized data entries. Each of the card keys stores a unique identification data entry that, corresponds to one of the authorized data entries. When a person carrying one of the card keys intends to enter the building, the one of the card keys is brought within an effective communication range of the access control apparatus in order to establish communication between the one of the card keys and the access control apparatus. The access control apparatus is operable to identify the identification data entry stored in the one of the card keys for comparison with the authorized data entries of the authorization list. When the identification data entry is deemed to foe valid (i.e., corresponds to one of the authorized data entries), the access control apparatus is operable to switch to an access-permitting mode (e.g., unlock the door at the entrance).

The administrator server is implemented with administrator functions including adding new authorized data entries to the authorization list, and deleting and/or modifying existing authorized data entries.

For example, when it is intended to authorize a new card key, an operator of the administrator server needs to set the identification data entry for the new card key using the administrator server, and then store the identification data entry in the authorization list as a new authorized data entry. The updated authorization list is then transmitted to the access control apparatus over a network. As a result, the access control apparatus may recognize the new card key as an authorized one.

One drawback, of the conventional access control system, is that the administrator functions can only foe executed using the administrator server, which is typically located in a place remote to the access control apparatus. Therefore, constructing the network between the access control apparatus and the administrator server may be somewhat costly. Additionally, the network may be vulnerable to hacking.

### SUMMARY OF THE INVENTION

Therefore, the object of the present invention is to provide an access control system that is configured to address the above drawbacks of the conventional access control system.

According to one aspect, an access control system of the present invention comprises a portable user device, an access control apparatus, and a portable administrator device.

The portable user device includes a near field communication (NFC) component and a memory component that stores an identification data entry corresponding to the portable user device.

The access control apparatus includes a first NFC unit, a first processor coupled to the first NFC unit, and a first memory storage that is coupled to the first, processor and that stores a first valid user list. The access control apparatus is operable to switch between an access-denying state and an access-permitting state.

The portable administrator device includes a second NFC unit, a second, processor coupled to the second NFC unit, and a second memory storage that is coupled to the second processor and that stores a second valid user list.

When the NFC component of the portable user device and the first NFC unit of the access control apparatus are placed within an effective communication range of each other, the NFC component and the first NFC unit are operable to enable communication between the portable user device and the access control apparatus to permit transmission of the identification data entry stored in the memory component of the portable user device to the access control apparatus. The first NFC unit then receives the identification data entry transmitted by the NFC component. The first processor is configured to determine whether or not the identification data entry received from the NFC component is valid with reference to the first valid user list stored in the first memory storage, and is configured to switch the access control apparatus to operate in the access-permitting state when the identification data entry is determined by the first processor to be valid.

When the first NFC unit of the access control apparatus and the second NFC unit of the portable administrator device are placed within an effective communication range of each other, the first NFC unit and the second NFC unit are operable to enable communication between the access control apparatus and the portable administrator device, and the first processor of the access control apparatus and the second processor of the portable administrator device are operable to synchronies contents of the first valid user list stored in the first memory storage and the second valid user list stored in the second memory storage.

According to another aspect, an access control system of the present invention comprises an access control apparatus and a portable administrator device.

The access control apparatus includes a first near field communication (NFC) unit, a first processor coupled to the first NFC unit, and a first memory storage that is coupled to the first processor and that stores a first valid user list.

The portable administrator device includes a second NFC unit, a second processor coupled to the second NFC unit, and a second memory storage that is coupled to the second processor and that stores a second valid user list. The second valid user list is associated with a portable user device that is adapted for controlling operation of the access control apparatus.

When the first NFC unit of the access control apparatus and the second NFC unit of the portable administrator device are placed within an effective communication range of each other, the first NFC unit and the second NFC unit are operable to enable communication between the access control apparatus and the portable administrator device, and the first processor of the access control apparatus and the second processor of the portable administrator device are operable to synchronize contents of the first valid user list stored in the first memory storage and the second valid user list stored in the second memory storage.

### BRIEF DESCRIPTION OF THE DRAWINGS

Other features and advantages of the present invention will become apparent in the following detailed description, of the preferred embodiments with reference to the accompanying drawings, of which:

FIG. 1 is a block diagram of a first preferred embodiment of an access control system according to the invention; and

FIG. 2 is a block diagram of a second preferred embodiment of an access control system according to the

### DETAILED DESCRIPTION OF THE PREFERRED EMBODIMENTS

Before the present invention is described in greater detail, it should be noted that like elements are denoted by the same reference numerals throughout the disclosure.

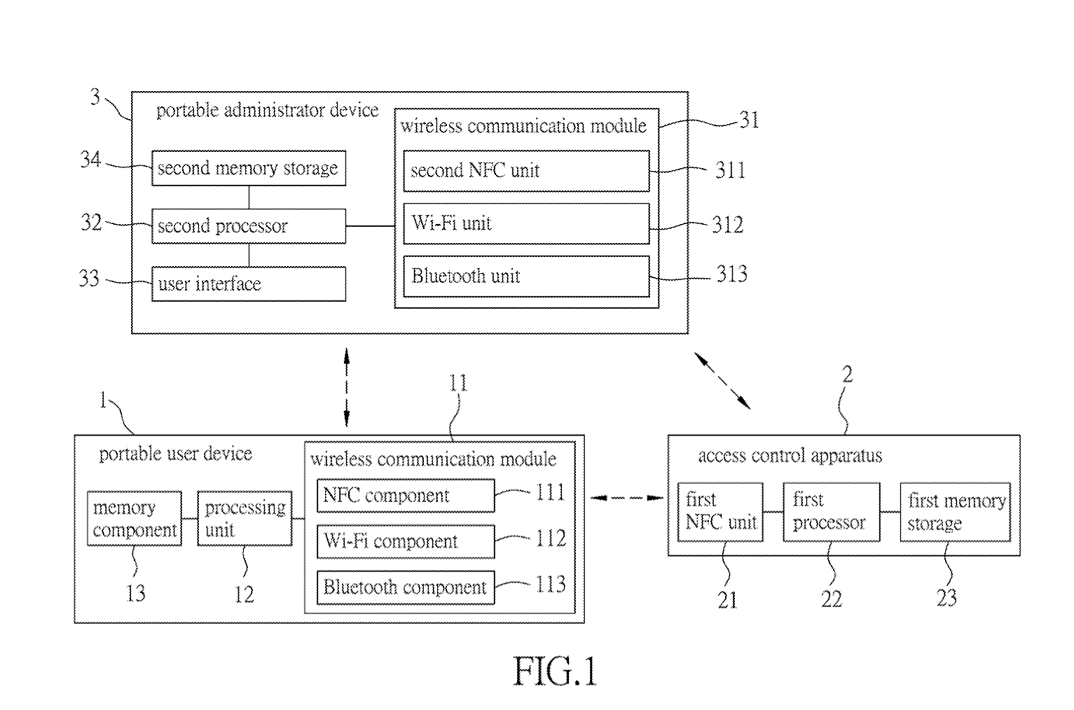

As shown in FIG. 1, the preferred embodiment of an access control system according to the present invention comprises a portable user device 1, an access control apparatus 2, and a portable administrator device 3. The access control apparatus 2 may be placed at a door of a building, and is operable to switch between an access-denying state (e.g., keep the door locked) and an access-permitting state (e.g., unlock the door temporarily). In other embodiments, additional portable user device 1 may be incorporated.

The portable user device 1 is embodied as a mobile phone in this embodiment, and includes a wireless communication module 11, a processing unit 12 coupled to the -wireless communication module 11, and a memory component 13 coupled to the processing unit 12. The wireless communication module 11 includes a near field communication (NFC) component 111, a Wi-Fi component 112, and a Bluetooth component 113. The memory component 13 stores an identification data entry that corresponds to the portable user device 1.

The access control apparatus 2 includes a first NFC unit 21, a first processor 22 coupled to the first NFC unit 21, and a first memory storage 23 that is coupled to the first processor 22 and that stores a first valid user list.

In this embodiment, the first valid user list stored in the first memory storage 23 includes at least one valid user identification data entry and at least one preset user data entry. Each of the valid user identification data entry and the preset user data entry includes an identification data portion and a security clearance data portion.

The portable administrator device 3 is embodied as a mobile phone in this embodiment, and includes a wireless communication module 31, a second processor 32 coupled to the wireless communication module 31, a user interface 33 coupled to the second processor 32, and a second memory storage 34 that is coupled to the second processor 32 and that stores a second valid user list. The wireless communication module 31 has a structure similar to that of the wireless communication module 11, and includes a second NFC unit 311, a Wi-Fi unit 312, and a Bluetooth unit 313.

In this embodiment, the second valid user list stored in the second memory storage 34 includes at least one valid user identification data entry and at least one preset user data entry. Each of the valid user identification data entry and the preset user data entry includes an identification data portion and a security clearance data portion.

When the first NFC unit 21 of the access control apparatus 2 and the second NFC unit 311 of the portable administrator device 3 are placed within an effective communication range of each other, the first NFC unit 21 and the second MFC unit 311 are operable to enable communication between the access control apparatus 2 and the portable administrator device 3. The first processor 22 of the access control apparatus 2 and the second processor 32 of the portable administrator device 2 are operable to synchronize contents of the first valid user list stored in the first memory storage 23 and the second valid user list stored in the second memory storage 34.

The user interface 33 of the portable administrator device 3 is for displaying information and enabling a user to interact with the portable administrator device 3. In particular, the second processor 32 is operable to execute an application stored in the second memory storage 34 to allow the user to operate the portable administrator device 3 for implementing a number of administrator actions. The administrator actions may include a new valid user addition procedure, a preset user data assignment procedure, a valid user data setting procedure, etc.

In this embodiment, before a portable user device 1 (e.g., a mobile phone) is authorized to serve as a valid card key, the new valid user addition procedure needs to foe implemented in advance.

The new valid user addition procedure may be implemented in a number of ways. For example, in a first exemplary implementation, a user operates the user interface 33 of the portable administrator device 3 to input a new valid user identification data entry, and to add the new valid user identification data entry to the second, valid user list stored in the second memory storage 34.

Afterward, the NFC component 111 of the portable user device 1 and the second NFC unit 31 of the portable administrator device 3 are placed within an effective communication range of each other. The NFC component ill and the second NFC unit 31 are then operable to enable peer-to-peer communication between the portable user device 1 and the portable administrator device 3 to permit transmission of the new identification data entry from the portable administrator device 3 to the portable user device 1, and the processing unit 12 is configured to store, in the memory component 13, the new identification data entry received by the NFC component 111 to serve as the identification data entry corresponding to the portable user device 1. Accordingly, the new valid user identification data entry added to the second valid user list is associated with the identification data entry corresponding to the portable user device 1.

In other implementations, communication between the portable user device 1 and the portable administrator device 3 can be established using one pair of the Wi-Fi component 112 and the Wi-Fi unit 312, and the Bluetooth component 113 and the Bluetooth unit 313,

Next, the first NFC unit 21 of the access control apparatus 2 and the second NFC unit 311 of the portable administrator device 3 are placed within an effective communication range of each other for enabling communication between, the access control apparatus 2 and the portable administrator device 3. The first processor 22 of the access control apparatus 2 then updates contents of the first valid user list stored in the first memory storage 23 based on the second valid user list stored in the second memory storage 34, thus rendering the portable user device 1 recognizable to the access control apparatus 2.

While in this implementation a particular order of the procedure is described, in other implementations, contents of the first valid user list and the second valid user list may be synchronized first.

In a second exemplary implementation, the identification data entry stored in the portable user device 1 is directly transmitted to the portable administrator device 3.

Specifically, the portable user device 1 and the portable administrator device 3 are first placed within the effective communication range of each other for interaction. The portable administrator device 3 is then operable to transmit a request to the portable user device 1, which in response permits transmission of the identification data entry stored in the memory component 13 from the portable user device 1 to the portable administrator device 3. The second processor 32 is then configured to store, in the second memory storage 34, the identification data entry received by the second NFC unit 311 to serve as the identification data portion of the valid user identification data entry. That is to say, the valid user identification data entry is associated with the identification data entry stored in the memory component 13 of the portable user device 1, and the identification data portion of the valid user identification data entry is uniquely associated with the identification data entry.

The first NFC unit 21 of the access control apparatus 2 and the second MFC unit 311 of the portable administrator device 3 are then placed within the effective communication range of each other to perform synchronization of contents of the first valid user list and the second valid user list.

In a third exemplary implementation, the identification data entry stored in the portable user device 1 is directly transmitted to the access control apparatus 2.

Specifically, the first NFC unit 21 of the access control apparatus 2 and the second NFC unit 311 of the portable administrator device 3 are first placed within the effective communication range of each other, and the second processor 32 is then operable to transmit a request to the access control apparatus 2.

Afterward, the first NFC unit. 21 of the access control apparatus 2 and the NFC component 111 of the portable user device 1 are placed within, the effective communication range of each other, and the portable user device 1 permits transmission of the identification data entry stored in the memory component 13 to the access control apparatus 2. The first processor 22 is then configured to store, in the first memory storage 23, the identification data entry received by the first NFC unit 21 to serve as the identification data portion of the valid user identification data entry. That is to say, the valid user identification data entry is associated with the identification data entry stored in the memory component 13 of the portable user device 1, and the identification data portion of the valid user identification data entry is uniquely associated with the identification data entry. The first NFC unit 21 of the access control apparatus 2 and the second NFC unit 311 of the portable administrator device 3 are then placed within an effective communication range of each other to perform synchronization of contents of the first valid user list and the second valid user list.

In this embodiment, when it is intended to assign the portable user device 1 as a valid card key using the preset user data entry (e.g., a temporary access), the preset user data assignment procedure is performed.

Specifically, the portable user device 1 and the portable administrator device 3 are first placed within the effective communication range of each other for interaction. The NFC component 111 and the second NFC unit 311 are operable to enable communication between, the portable user device 1 and the portable administrator device 3 to permit transmission of the identification data portion of the preset user data entry from the portable administrator device 3 to the portable user device 1, and the processing unit 12 is configured to store in the memory component 13 the identification data portion of the preset user data entry received by the NFC component 111 to serve as the identification data entry.

It is noted that, since the preset user data entry is stored in both the access control apparatus 2 and the portable administrator device 3 beforehand, the preset user data assignment procedure does not require synchronization of contents of the first valid user list and the second valid user list.

In some embodiments, the preset user data entry may be a shared guest data entry that can be assigned temporarily to a number of different, portable user devices 1.

After the portable user device 1 has been successfully validated using one of the procedures described above, the portable user device 1 may be utilized as a card key to operate the access control apparatus 2 for gaining access.

In particular, when the NFC component 111 of the portable user device 1 and the first NFC unit 21 of the access control apparatus 2 are placed within the effective communication range of each other, communication between the portable user device 1 and the access control, apparatus 2 may be enabled, and transmission of the identification data entry in the memory component 13 of the portable user device 1 to the access control apparatus 2 may be processed. The first processor 22 is configured to determine whether or not the identification data entry received by the first NFC unit 21 is valid with reference to the first valid user list stored in the first memory storage 23, and is configured to switch the access control apparatus 2 to operate in the access-permitting state when the identification data entry is determined by the first processor 22 to be valid.

To be specific, the determination made by the first processor 22 is executed in the following manner. Firstly, the first processor 22 compares the received identification data entry with the identification data portion of both the valid user identification data entry and the preset user data entry in the second valid user list. When correspondence is found between the identification data entry and one of the identification data portion of one of the valid user identification data entry and the preset user data entry, the first processor 22 further compares the received identification, data entry with the security clearance data portion (e.g., a clearance time period during which the holder of the portable user device I is permitted access) of the one of the valid user identification data entry and the preset user data entry. When the security clearance data portion indicates that the identification data entry is valid, the first processor 22 switches the access control apparatus 2 to operate In the access-permitting state.

It is understood that the comparison of the received identification data entry with the security clearance data portion may he optional (for example, the valid user identification data entry may be granted access regardless of the current time). In other embodiments, additional verification procedures may be undertaken.

When it is to delete/modify one of the valid user identification data entry and the preset user data entry (or one of the valid user identification data entries when a plurality of valid user identification data entries are provided), the valid user data setting procedure is executed in the following manner.

The access control apparatus 2 and the portable administrator device 3 are first placed within the effective communication range of each other. The user interface 33 is then operated for instructing the second processor 32 to delete/modify contents of the second valid user list. Afterward, the updated second valid user list can be transmitted to the access control apparatus 2 for updating the first valid user list accordingly, It is noted that only the access control apparatus 2 and the portable administrator device 3 are involved in this procedure.

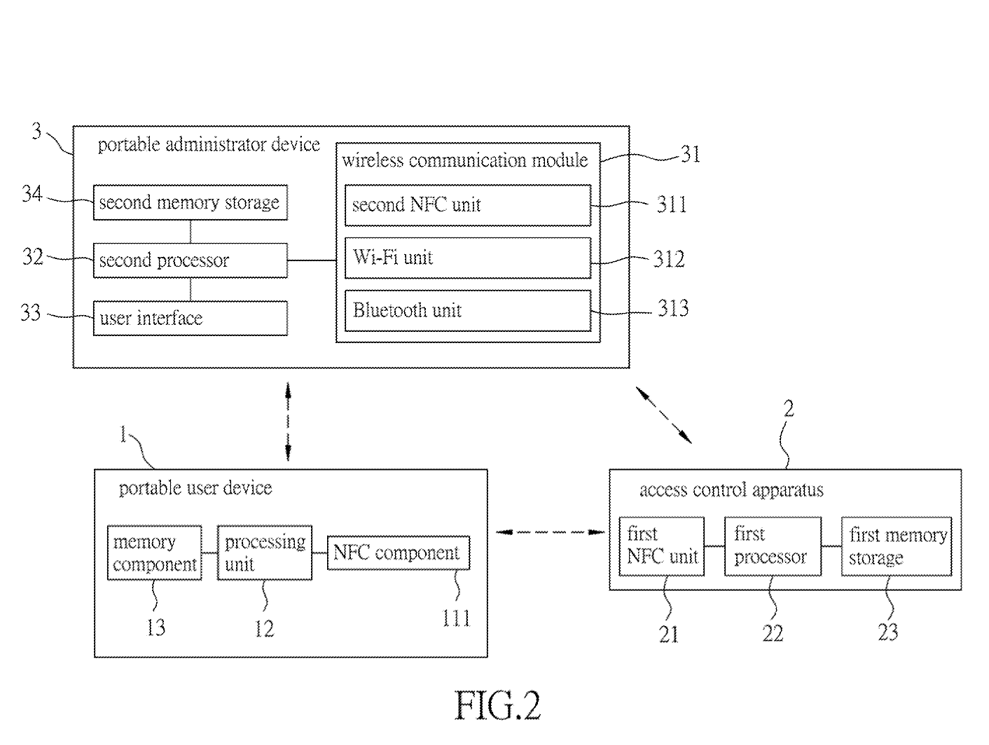

As shown in FIG. 2, the second preferred embodiment of the access control system according to the present invention has a structure similar to that of the first embodiment. The main difference between this embodiment and the previous embodiment resides in the configuration of the portable user device 1, which is embodied as an electronic card. As a result, the wireless communication module of the portable user device 1 only includes the NFC component 111, and communication between the portable user device 1 and the access control apparatus 2 or the portable administrator device 3 is exclusively via near field communication.

In one embodiment, there is provided an access centre I system. The access control system comprises an access control apparatus 2 and a portable administrator device 3.

The access control apparatus 2 includes a first near field communication (NFC) unit 21, a first processor 22 coupled to the first NFC unit 21, and a first memory storage 23 that is coupled to the first processor 22 and that stores a first valid user list.

The portable administrator device 3 includes a second NFC unit 311, a second, processor 32 coupled to the second NFC unit 311, and a second memory storage 34 that is coupled to the second processor 32 and that stores a second valid user list. The second valid user list is associated with a portable user device 1 that is adapted for controlling operation of the access control apparatus 2. The portable administrator device 3 may be embodied using a mobile phone.

The access control system is configured such that when the first NFC unit 21 of the access control apparatus 2 and the second NFC unit 311 of the portable administrator device 3 are placed within an effective communication range of each other, the first NFC unit 21 and the second NFC unit 311 are operable to enable communication between the access control apparatus 2 and the portable administrator device 3, and the first processor 22 of the access control apparatus 2 and the second processor 32 of the portable administrator device 3 are operable to synchronize contents of the first valid user list stored in the first memory storage 23 and the second valid user list stored in the second memory storage 34.

The second valid user list stored in the second memory storage 34 may include a valid user identification data entry that is associated with the portable user device 1. The valid user identification data entry may include an identification data portion that is uniquely associated with the portable user device 1.

The second NFC unit 311 of the portable administrator device 3 may be configured to communicate with the portable user device 1 using near field communication to permit transmission of an identification data entry from the portable user device 1 to the portable administrator device 3. The second processor 32 may be configured to store in the second memory storage 34 the identification data entry received by the second NFC unit 311 to serve as the identification data portion of the valid user identification data entry corresponding to the portable user device 1.

The second valid user list stored in the second memory storage 34 of the portable administrator device 3 may include a preset user data entry having an identification data portion for association with the portable user device 1.

The second NFC unit 311 of the portable administrator device 3 may be configured to communicate with the portable user device 1 using near field communication to permit transmission of the identification data portion of the preset user data entry from the portable administrator device 3 to the portable user device 1.

To sum up, embodiments of the access control system, of this invention utilize the first and second NFC units 21 and 311 for communication between the access control apparatus 2 and the portable administrator device 3, thereby eliminating the need for constructing a network therebetween. Furthermore, since near field, communication is considered a closed network, the contents stored in the components of the access control system can be made more resistant to hacking.

While the present invention has been described in connection with what are considered the most practical and preferred embodiments, it is understood that this invention is not limited to the disclosed embodiments but is intended to cover various arrangements included within the spirit and scope of the broadest interpretation so as to encompass ail such modifications and equivalent arrangements.

What is claimed is:

1. An access control system comprising:
a portable user device including a near field communication (NFC) component and a memory component that stores an identification data entry corresponding to said portable user device;
an access control apparatus including a first NFC unit, a first processor coupled to said first NFC unit, and a first memory storage that is coupled to said first processor and that stores a first valid user list, said access control apparatus being operable to switch between an access-denying state and an access-permitting state; and
a portable administrator device including a second NFC unit, a second processor coupled to said second NFC unit, and a second memory storage that is coupled to said second processor and that stores a second valid user list;
wherein, when said NFC component of said portable user device and said first NFC unit of said access control apparatus are placed within an effective communication range of each other, said NFC component and said first NFC unit are operable to enable communication between said portable user device and said access control apparatus to permit transmission of the identification data entry stored in said memory component of said portable user device to said access control apparatus, said first NFC unit receives the identification data entry transmitted by said NFC component, said first processor is configured to determine whether or not the identification data entry received from said NFC component is valid with reference to the first valid user list stored in said first memory storage, and said first processor is configured to switch said access control apparatus to operate in the access-permitting state when the identification data entry is determined by said first processor to be valid;
wherein, when said first NFC unit of said access control apparatus and said second NFC unit of said portable administrator device are placed within an effective communication range of each other, said first NFC unit and said second NFC unit are operable to enable communication between said access control apparatus and said portable administrator device, and said first processor of said access control apparatus and said second processor of said portable administrator device are operable to synchronize contents of said first valid user list stored in said first memory storage and said second, valid user list stored in said second memory storage.

2. The access control system of claim 1, wherein said portable administrator device is a mobile phone.

3. The access control system of claim 1, wherein said second valid user list stored in said second memory storage includes a valid user identification data entry that is associated with said identification data entry stored in said memory component of said portable user device.

4. The access control system of claim 3, wherein said valid user identification data entry includes an identification data portion that is uniquely associated with said identification data entry stored in said memory component of said portable user device.

5. The access control system of claim 4, wherein, when said NFC component of said portable user device and said second NFC unit of said portable administrator device are placed within an effective communication range of each other, said NFC component and said second NFC unit are operable to enable communication between said portable user device and said portable administrator device to permit transmission of said identification data entry from said portable user device to said portable administrator device, and said second processor is configured to store in said second memory storage said identification data entry received by said second NFC unit to serve as said identification data portion of said valid user identification data entry corresponding to said portable user device.

6. The access control system of claim 1, wherein said second valid user list stored in said, second memory storage of said portable administrator device includes a preset, user data entry having an identification data portion for association with said identification data entry stored in said memory component of said portable user device.

7. The access control system of claim 6, wherein, when said NFC component of said portable user device and said second NFC unit of said portable administrator device are placed within an effective communication range of each other, said NFC component and said second NFC unit are operable to enable communication between said portable user device and said portable administrator device to permit transmission of said identification data portion of said preset user data entry from said portable administrator device to said portable user device, and said portable user device is configured to store in said memory component said identification data portion of said preset user data entry received by said NFC component to serve as said identification data entry.

8. The access control system of claim 1, wherein said portable user device is one of a mobile phone and an electronic card.

9. An access control system comprising:
an access control, apparatus including a first near field communication (NFC) unit, a first processor coupled to said first NFC unit, and a first memory storage that is coupled to said first processor and that stores a first valid user list; and
a portable administrator device including a second NFC unit, a second processor coupled to said second MFC unit, and a second memory storage that is coupled to said second processor and that stores a second valid user list, said second valid user list being associated with a portable user device that is adapted for controlling operation of said access control apparatus;
wherein, when said first NFC unit of said access control apparatus and said second NFC unit of said portable administrator device are placed within an effective communication range of each other, said first NFC unit and said second NFC unit are operable to enable communication between said access control apparatus and said portable administrator device, and said first processor of said access control apparatus and said second processor of said portable administrator device are operable to synchronize contents of said first valid user list stored in said first memory storage and said second valid user list stored in said second memory storage.

10. The access control system of claim 9, wherein said portable administrator device is a mobile phone.

11. The access control system of claim 9, wherein said second valid user list stored in said second memory storage includes a valid, user identification data entry that is associated with the portable user device.

12. The access control system of claim 11, wherein said valid user identification data entry includes an identification data portion that is uniquely associated with the portable user device.

13. The access control system of claim 12, wherein said second NFC unit of said portable administrator device is configured to communicate with the portable user device using near field communication to permit transmission of an identification data entry from the portable user device to said portable administrator device, and said second processor is configured to store in said second memory storage the identification data entry received by said second NFC unit to serve as said identification data portion of said valid user identification data entry corresponding to the portable user device.

14. The access control system of claim 9, wherein said second valid user list stored in said second memory storage of said portable administrator device includes a preset user data entry having an identification data portion for association with the portable user device.

15. The access control system of claim 14, wherein said second NFC unit of said portable administrator device is configured to communicate with the portable user device using near field communication to permit transmission of said identification data portion of said preset user data entry from said portable administrator device to the portable user device.
